(19) United States
(12) Patent Application Publication
(10) Pub. No.: US 2024/0248445 A1
(43) Pub. Date: Jul. 25, 2024

(54) ENERGY MANAGEMENT SYSTEM

(71) Applicant: Inventus Holdings, LLC, Juno Beach, FL (US)

(72) Inventors: KENNETH A. WILLIAMS, MINNEAPOLIS, MN (US); JING YANG LI, Lino Lakes, MN (US); GORDON W. PAYNTER, FALCON HEIGHTS, MN (US); TARAN RAJ, ST. PAUL, MN (US); DANISH SHRESTHA, Lynnwood, WA (US); SRIHARSHA VEERAMACHANENI, MINNEAPOLIS, MN (US)

(21) Appl. No.: 18/498,782

(22) Filed: Oct. 31, 2023

Related U.S. Application Data
(60) Provisional application No. 63/481,447, filed on Jan. 25, 2023.

(51) Int. Cl. G05B 19/042

(52) U.S. Cl. CPC G05B 19/042; G05B 2219/2639

(57) ABSTRACT

An energy management system includes processing agents that each include a run function to provide a data request for energy-related data and generate an output. A messaging interface receives the energy-related data from data nodes associated with external organizations, power generating facilities, and/or other processing agents in response to the data request, publishes the energy-related data to the requesting processing agent, receives the output from the respective processing agent, and provides the output to other processing agents and/or data nodes. A simulation controller selectively replaces the energy-related data with simulation data for data nodes. An output resolver generates an energy management output based on the outputs provided by processing agents and generates the simulation data based on a deviation in the energy management output resulting from application of the simulation data relative to application of the energy-related data to determine a solution associated with the power generating facilities.

### RELATED APPLICATIONS

This application claims priority from U.S. Patent Application Ser. No. 63/481447, filed 25 Jan. 2023, which is incorporated herein by reference in its entirety.

### TECHNICAL FIELD

This disclosure relates generally to power systems, and more specifically to an energy management system.

### BACKGROUND

Automation and computer-assisted control plays an important role in our current society. In the context of power generation, computer systems take an active role in controlling the operation of power generation systems and facilities. Power consumers can interface with power generation systems and facilities on an energy marketplace, providing for interaction between the producers and consumers of energy. As control systems become more prevalent and Internet-connected, the interaction between energy production and consumption can be more online, allowing for a diverse set of energy production and consumption options. Furthermore, ancillary organizations may monitor data that can affect the production and/or consumption of energy, which can further facilitate interactions between the producers of energy and the ancillary organizations to provide for more accurate estimates of energy production and energy availability for consumers.

### SUMMARY

One example includes an energy management system. The energy management system includes processing agents that each include a run function to provide a data request for energy-related data and generate an output. A messaging interface receives the energy-related data from data nodes associated with external organizations, power generating facilities, and/or other processing agents in response to the data request, publishes the energy-related data to the requesting processing agent, receives the output from the respective processing agent, and provides the output to other processing agents and/or data nodes. A simulation controller selectively replaces the energy-related data with simulation data for data nodes. An output resolver generates an energy management output based on the outputs provided by processing agents and generates the simulation data based on a deviation in the energy management output resulting from application of the simulation data relative to application of the energy-related data to determine a solution associated with the power generating facilities.

Another example includes a method for operating an energy management system. The method includes generating a data request for energy-related data from each of a plurality of processing agents and transmitting the data request from each of the processing agents to a respective one of a plurality of data nodes that are each associated with associated with one of a respective organization, a respective one of a plurality of power generating systems, or another one of the processing agents via a messaging interface. The method also includes transmitting the energy-related data from each of the data nodes to the respective processing agents via the messaging interface and generating an output that is associated with the energy-related data from each of the processing agents based on a programmed run function associated with each of the respective processing agents. The method also includes transmitting the output that is associated with the energy-related data from each of the processing agents to at least one of other processing agents and respective data nodes and generating a first energy management output based on the output generated by at least one of the respective processing agents in response to the energy-related data via an output resolver. The method also includes selectively replacing the energy-related data provided from at least one of the data nodes with simulation data and generating a second energy management output based on the output generated by at least one of the respective processing agents in response to the simulation data via the output resolver. The method further includes identifying a deviation between the first energy management output and the second energy management output, and generating a solution associated with one or more of the power generating facilities based on the deviation.

Another example includes a non-transitory computer readable medium comprising machine-readable instructions. The machine-readable instructions are executed to generate a plurality of processing agents, each of the processing agents comprising a run function configured to provide at least one data request for energy-related data and to generate at least one output that is associated with the energy-related data. The machine-readable instructions are also executed to generate a messaging interface that is configured to receive the energy-related data from one or more data nodes that are each associated with one of a respective external organization, a respective one of a plurality of power generating facilities, or another one of the processing agents in response to the at least one data request, to publish the energy-related data to the respective processing agents, to receive the at least one output associated with the energy-related data from the respective processing agents, and to provide the at least one output to at least one of other processing agents and respective data nodes. The machine-readable instructions are also executed to generate a simulation controller that is configured to selectively replace the energy-related data with simulation data for one or more of the data nodes. The machine-readable instructions are further executed to generate an output resolver that is configured to generate an energy management output based on at least one of the at least one output provided by a respective at least one of the respective processing agents. The output resolver can be further configured to generate the simulation data based on deviations in the energy management output resulting from application of the simulation data relative to application of the energy-related data and to iteratively generate the energy management output and to refine the simulation data at each iteration based on the energy management output that is generated in response to a set of the simulation data in an immediately preceding iteration to determine a solution associated with one or more of the power generating facilities.

### BRIEF DESCRIPTION OF THE DRAWINGS

FIG. 1 illustrates an example of a utility power system.

FIG. 2 illustrates an example block diagram of an energy management system.

FIG. 3 illustrates an example block diagram of messaging in an energy management system.

FIG. 4 illustrates an example block diagram of simulation capability of an energy management system.

FIG. 5 illustrates an example of a method for operating an energy management system.

### DETAILED DESCRIPTION

This disclosure relates generally to power systems, and more specifically to an energy management system. The energy management system can be implemented as a framework to facilitate communication between and control of multiple aspects of energy production, provision, and consumption. For example, the energy management system can provide for messaging interaction between data nodes associated with different organizations and energy producing facilities to generate an energy management output that is associated with a solution for a given utility power system. The solution can be any of a variety of aspects of the utility power system, such that the energy management system can facilitate interaction and control for any or all facets of energy production and consumption. Example solutions of the energy management system can include providing control of operational aspects of energy production, creating energy offers on an energy marketplace for consumption of energy, and monitoring aspects of energy production and consumption, such as carbon production and reduction of facilities from energy production to customer consumption.

The energy management system can also facilitate simulation of any or all aspects of the data transfer between the data nodes of the energy management system. For example, a simulation controller can selectively replace data that is provided to or from any of the data nodes with simulation data. The simulation data can thus be propagated through the energy management system to determine the energy management output associated with the solution based on the simulated conditions represented by the simulation data. As another example, the simulation data can be generated based on the energy management output that is generated by other simulation data, such that the simulation data can be generated iteratively in a feedback manner to optimize the solution. Accordingly, the solution can be generated in an offline manner to provide for a more efficient or effective solution for the utility power system and/or to determine errors or problems with the power generation facilities.

The energy management system includes a plurality of processing agents that each include a specific run function. As an example, the processing agents can be implemented as software extensions (e.g., Python classes) that can be generated by an agent generation tool to facilitate specifically defined work units in the energy management system. The run function can correspond to generating periodic data requests from the processing agent for energy-related data and periodically generating an output that is associated with the energy-related data. For example, the processing agent can process the energy-related data to obtain the output, or can republish the energy-related data as the output (e.g., for different recipient data nodes in the energy management system). The processing agents can be configured to perform the run function at each of a trigger signal provided from a timing controller. The trigger signal can be provided periodically based on a real-time clock, or can be provided from the simulation controller to simulate time duration of the real-time clock. As an example, the processing agents can be agnostic as to whether the energy-related data and/or the trigger signal inputs are provided during real-time operation or provided in a simulation environment, such that the processing agents provide the programmed run function regardless of real-time or simulated operation of the energy management system.

The energy management system also includes a messaging interface that can operate as a communications framework for the messages that are sent between the processing agents and the data nodes in the energy management system. The messages can thus include all of the data requests from the processing agents, the requested data from the data nodes, and the outputs provided from the processing agents to the data nodes. For example, the messaging interface can receive the data requests from the processing agents, obtain the requested data from the data nodes and publish the requested data to the processing agents, receive the outputs from the processing agents, and provide the outputs to associated data nodes. As an example, the messaging interface can include a format translation layer that is configured to convert the messages that are provided to the messaging interface in a common processing format that is implemented by the messaging interface. The messaging interface can thus convert the messages from the common messaging format to a native format implemented by the respective processing agents and data nodes to provide the messages to the recipient processing agents and data nodes.

One or more of the data nodes can thus provide or perform some function in response to the outputs provided from the processing agents via the messaging interface. For example, the outputs can, in the aggregate, correspond to or be used to determine a solution for the utility power system. The energy management system can also include an output resolver that is configured to generate the energy management output that can be associated with the solution for the utility power system. The output resolver can, for example, determine the energy management output, such that the energy management output can be published to one or more data nodes of respective power generation facilities or related organizations via the messaging interface. The output resolver can also generate the simulation data that can be implemented by the simulation controller to selectively replace the data that is provided to or from the data nodes. As described above, the output resolver can generate the simulation data based on the energy management output that is generated by other simulation data, such that the simulation data can be generated iteratively in a feedback manner to optimize the solution for the power utility system.

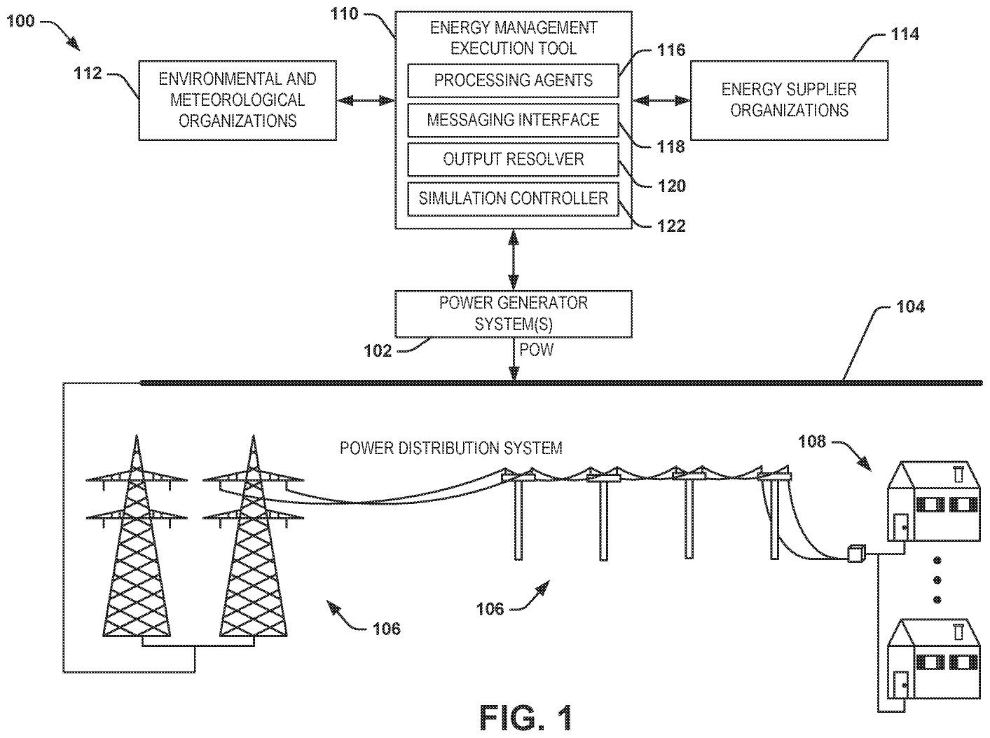

An energy management system can be implemented in any of a variety of utility power systems, such as demonstrated in the example of FIG. 1. FIG. 1 illustrates an example of a utility power system 100. The utility power system 100 includes at least one power generator system 102 that is configured to provide power, demonstrated in the example of FIG. 1 as POW, to a power grid 104. The power generator system(s) 102 can each correspond to any of a variety of power generator systems, such as fossil-fuel power generator systems, nuclear power generator systems, solar or wind power generator systems, etc. The power grid 104 can correspond to power buses and/or points-of-interconnect (POIs) that provide power via a power distribution system 106 (e.g., transformers, substations, and power lines) to consumers, demonstrated generally at 108.

The utility power system 100 includes an energy management system 110 that can be implemented as a framework to facilitate communication between and control of multiple aspects of energy production, provision, and consumption with respect to the power generator system(s) 102 and the consumers 108. For example, the energy management system 110 can provide for messaging interaction between data nodes associated with different organizations and energy producing facilities to generate an energy management output that is associated with the utility power system 100. The energy management output can be associated with determining a solution associated with the power generator system(s) 102. Examples include a solution for determining an amount of power to provide, troubleshooting faulty equipment, determining an optimal revenue generation model for power providing, optimizing equipment for the power generator system(s) 102, etc. The solution can be any of a variety of aspects of the utility power system 100, such that the energy management system can facilitate interaction and control for any or all facets of energy production and consumption.

The data nodes can correspond to the control nodes associated with each of the power generator system(s) 102, monitoring equipment associated with the power grid 104 and/or the power distribution systems 106, and organizations that service the consumers 108 (e.g., local power companies and/or online energy marketplaces). The data nodes can also include control nodes and data distribution hubs associated with outside organizations that may have an ancillary effect on the distribution of power to the consumers 108. In the example of FIG. 1, the outside organizations can include environmental and meteorological organizations 112. The environmental and meteorological organizations 112 can include organizations that provide meteorological data that can be determinative of solar and/or wind power production. The outside organizations can also include energy supplier organizations 114 that can supply and/or ship raw materials for providing power and/or provide a marketplace for energy consumption.

The energy management system 110 includes a plurality of processing agents 116 that each include a specific run function. As an example, the processing agents 116 can be implemented as software extensions that can be generated by an agent generation tool to facilitate specifically defined work units in the energy management system 110. The run function can correspond to generating periodic data requests from the processing agent 116 for energy-related data and periodically generating an output that is associated with the energy-related data. For example, the processing agent 116 can process the energy-related data to obtain the output, or can republish the energy-related data as the output (e.g., for different recipient data nodes in the energy management system 110). As an example, the processing agents 116 can be configured to perform the run function at each of a trigger signal provided from a timing controller, such as periodically based on a real-time clock.

The energy management system 110 also includes a messaging interface 118 that can operate as a communications framework for the messages that are sent between the processing agents 116 and the data nodes in the energy management system 110. The messages can thus include all of the data requests from the processing agents 116, the requested data from the data nodes, and the outputs provided from the processing agents 116 to the data nodes. For example, the messaging interface 118 can receive the data requests from the processing agents 116, obtain the requested data from the data nodes and publish the requested data to the processing agents 116, receive the outputs from the processing agents 116, and provide the outputs to associated data nodes. As an example, the messaging interface 118 can include a format translation layer that is configured to convert the messages that are provided to the messaging interface 118 in a common processing format that is implemented by the messaging interface 118. The messaging interface 118 can thus convert the messages from the common messaging format to a native format implemented by the respective processing agents 116 and data nodes to provide the messages to the recipient processing agents 116 and data nodes.

One or more of the data nodes can thus provide or perform some function in response to the outputs provided from the processing agents 116 via the messaging interface 118. For example, the outputs can, in the aggregate, correspond to or be used to determine a solution for the utility power system 100. In the example of FIG. 1, the energy management system 110 also includes an output resolver 120 that is configured to generate the energy management output that can be associated with the solution for the utility power system 100. The output resolver 120 can, for example, determine the energy management output and publish the energy management output to one or more data nodes of the power generator system(s) 102, the environmental and meteorological organizations, and/or the energy supplier organizations 114 via the messaging interface 118.

The energy management system 110 also includes a simulation controller 122. The simulation controller 122 can be configured to selectively replace energy-related data provided to or from the data nodes (e.g., associated with the power generator system(s) 102, the environmental and meteorological organizations 112, and/or the energy supplier organizations 114) with simulation data in order to simulate operation of aspects of the utility power system 100. For example, the simulation data can thus be propagated through the energy management system 110 to determine the energy management output associated with the solution based on the simulated conditions represented by the simulation data. As another example, the simulation data can be generated by the output resolver 120 based on the energy management output that is generated by simulation data, such that the simulation data can be generated iteratively in a feedback manner to optimize the solution. Additionally, the messaging interface 118 can include a simulation toggle, such as to facilitate a simulation mode of the messaging interface 118 to selectively simulate the energy-related data associated with one or more of the data nodes in the energy management system 110. Accordingly, by implementing the simulation controller 122 to selectively provide the simulation data, the solution can be generated in an offline manner to provide for a more efficient or effective solution for the utility power system 100 and/or to determine errors or problems with the power generator system(s) 102.

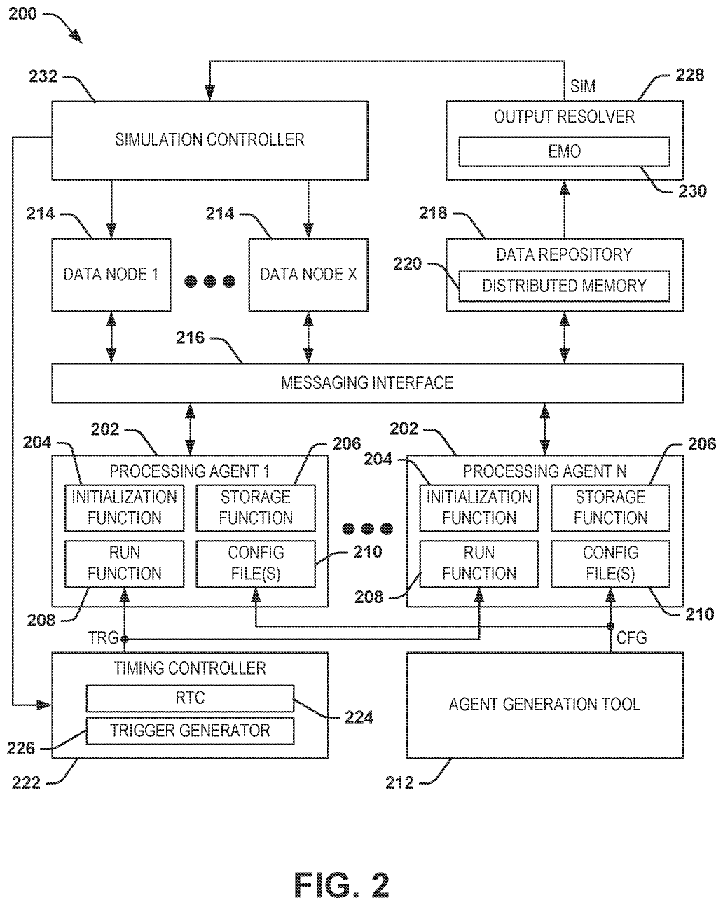

FIG. 2 illustrates an example block diagram of an energy management system 200. The energy management system 200 can correspond to the energy management system 110 in the example of FIG. 1. Therefore, reference is to be made to the example of FIG. 1 in the following description of the example of FIG. 2.

The energy management system 200 includes a plurality N of processing agents 202, where N is a positive integer. As an example, the processing agents 202 can be implemented as software extensions, such as defined by software extensions/classes (e.g., in Python or another programming language). In the example of FIG. 2, each of the processing agents 202 includes an initialization function 204, a storage function 206, a run function 208, and one or more configuration files (“CONFIG FILE(S)”) 210.

The initialization function 204 can include a variety of initialization operations to set up the respective processing agent 202 and perform necessary pre-processing before a first time step is executed, as described in greater detail herein. The initialization function 204 can also parse all configuration arguments (e.g., from one or more of the configuration files 210) to be used during simulation within this respective programming agent, as also described in greater detail herein.

The storage function 206 can be configured to store data in a specified message format. The data can correspond to messages that are transmitted from the processing agent 202 and provided to the processing agent 202, such as from data nodes and/or from other processing agents 202. For example, the messages can be provided as message abstractions to allow for accommodation of time series data such as datetime notion and various timestamps describing the time in which a certain piece of information was made available within the energy management system 200. For example, the datetime notion can include the time a certain piece of information was generated and the time for which a certain piece of information applies or is valid.

The run function 208 defines the core actions of the respective processing agent 202. In the example of FIG. 2, the processing agents 202 each receive a trigger signal TRG that define a time step to implement a work unit defined by the run function 208. At each time step, the run function 208 can prompt an action defined by the run function 208. For example, at a first time step, the run function 208 can publish a data request for energy-related data. At a second time step, the run function 208 can process the energy-related data in response to receiving the energy-related data (e.g., from a data node). At a third time step, the run function 208 can generate an output that is associated with the processed energy-related data. At a fourth time step, the run function 208 can publish the output associated with the energy-related data. As another example, the run function 208 can republish the energy-related data, such as to different recipients.

The configuration file(s) 210 correspond to the files that establish the respective processing agent 202. In the example of FIG. 2, the energy management system 200 includes an agent generation tool 212 that facilitates creation of the processing agents 202. For example, the agent generation tool 212 can correspond to a software application or programming interface (e.g., at a computer terminal) that can be implemented to create the configuration file(s) 210 to generate a given one or more of the processing agents 202. In the example of FIG. 2, the configuration file(s) 210 are provided to each of the processing agents 202 as a signal CFG, which can correspond to creation of a processing agent 202 or modification of a processing agent 202 via the configuration file(s) 210. As an example, the processing agents 202 can be generated in an open-ended architectural manner, such that the different sets of configuration files 210 from different software applications can be used to generate the processing agents 202 for the given energy management system 200.

The energy management system 200 also includes a plurality X of data nodes 214, where X is a positive integer. The data nodes 214 can correspond to communication interconnects to each of different facilities, organizations, or other aspects of the utility power system 100. For example, the data nodes 214 can each be associated with a respective one of the power generator system(s) 102, the environmental and meteorological organizations 112, and the energy supplier organizations 114. As another example, each of the power generator system(s) 102, the environmental and meteorological organizations 112, and the energy supplier organizations 114 can include multiple data nodes 214 that are each associated with a different data generating and/or data consuming aspect of the respective system or organization (e.g., available energy providing capability, available materials, financial aspects, etc.). The run function 208 of each of the processing agents 202 can thus publish requests for the energy-related data from one or more of the data nodes 214, as well as other processing agents 202, and can publish the output associated with the energy-related data to one or more of the data nodes 214, as well as other processing agents 202.

As an example, the processing agents 202 can operate based on mandatory data, such that a given processing agent 202 can be configured to not provide the output associated with the energy-related data until it receives mandatory energy-related data. As another example, one or more of the processing agents 202 can operate based on optional data, such that the output can be associated with mandatory energy-related data, but can also include data that is associated with optional energy-related data if the optional energy-related data was received by the processing agent 202 from the associated data node 214. For example, a given processing agent 202 can report a current state of charge of a battery power system as the output related to mandatory energy-related data. However, in this example, in addition to the mandatory information regarding the current state of charge, the output provided from the processing agent 202 can also include a statistical minimum or maximum rate of change of the charge of the battery power system. Such information in this example could thus provide insurance or indemnification of guarantees of power providing capacity for the battery power system. Therefore, as an example, the optional data that can be provided to and from a respective processing agent 202 can provide further context for the mandatory data that is provided as an output from the processing agent 202.

The energy management system 200 also includes a messaging interface 216 that operates as a communications framework for the messages that are sent between the processing agents 202 and the data nodes 214 in the energy management system 200. The messages can thus include all of the data requests from the processing agents 202, the requested data from the data nodes 214, and the outputs provided from the processing agents 202 to the data nodes 214. The messages can also include messages between the processing agents 202. For example, the messaging interface 216 can receive the data requests from the processing agents 202, obtain the requested data from the data nodes 214 and publish the requested data to the processing agents 202, receive the outputs from the processing agents 202, and provide the outputs to associated data nodes 214. As an example, the messaging interface 216 can include a format translation layer that is configured to convert the messages that are provided to the messaging interface 216 in a common processing format that is implemented by the messaging interface 216. The messaging interface 216 can thus convert the messages from the common messaging format to a native format implemented by the respective processing agents 202 and data nodes 214 to provide the messages to the recipient processing agents 202 and data nodes 214. As an example, the messaging interface 216 can be configured to facilitate communication between the processing agents 202 and the data nodes 214 across a network, such as a local area network (LAN), a wide area network (WAN), or the Internet.

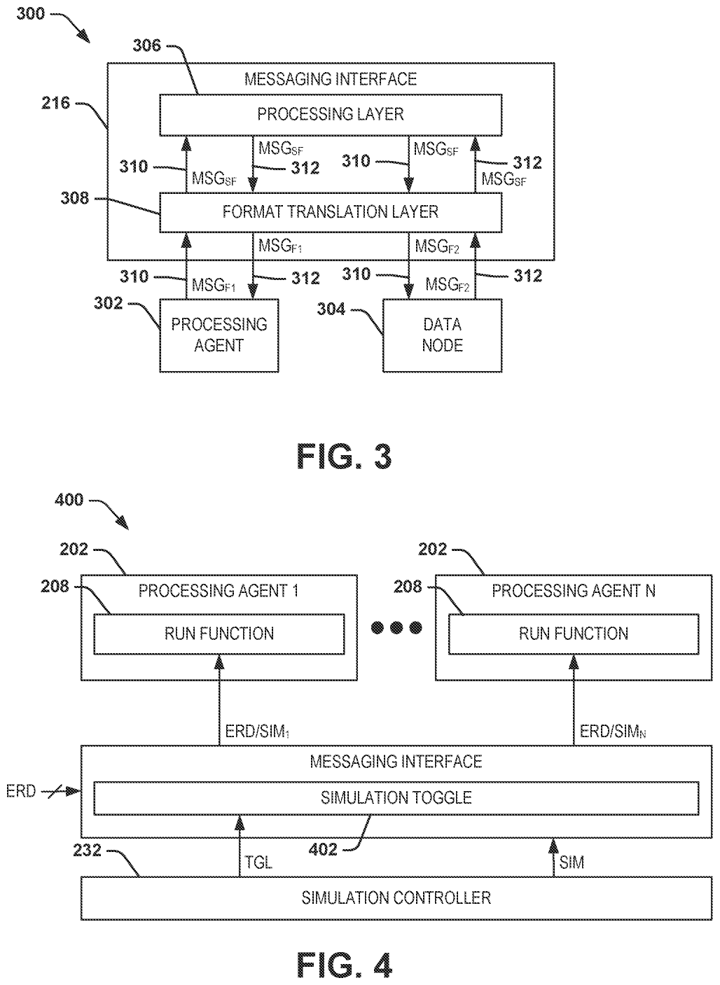

FIG. 3 illustrates an example block diagram 300 of messaging in the energy management system 200. The diagram 300 can correspond to the messaging that is propagated by and through the messaging interface 216. Therefore, reference is to be made to the example of FIG. 2 in the following description of the example of FIG. 3.

The diagram 300 includes the messaging interface 216, a processing agent 302, and a data node 304. The processing agent 302 can correspond to one of the processing agents 202 in the example of FIG. 2 and the data node 304 can correspond to one of the data nodes 214 in the example of FIG. 2. In the example of FIG. 3, the messaging interface 216 includes a format translation layer 306 and a processing layer 308. The format translation layer 306 is configured to convert messaging formats of messages between native data formats of the processing agents 202 and the data nodes 214 and a common processing format associated with the messaging interface 216. Therefore, the messaging interface 216 can be implemented to facilitate communication between the processing agents 202 and the data nodes 214 in any different data formats and/or messaging protocols. As an example, the format translation layer 306 can be implemented in an open-ended architecture to facilitate modification to accommodate any new messaging protocol or data format of respective newly added processing agents 202 and/or data nodes 214.

In the example of FIG. 3, the processing agent 302 is configured to generate a first message 310 in a first data format MSG_{F1} that is native to the respective processing agent 302. As an example, the first message 310 can correspond to a data request for energy-related data from the data node 304. The first message 310 is published to the messaging interface 216. The format translation layer 306 of the messaging interface 216 is configured to convert the first data format MSG to a common messaging format MSG_{SF}. Upon the first message 310 being provided in the common messaging format MSG_{SF}, the processing layer 308 can process the first message 310, such as to determine one or more recipients (e.g., the data node 304) and/or to provide any additional processing on the first message 310 (e.g., to provide the first message 310 as a request for the corresponding energy-related data). In response to determining that the first message 310 is intended for the data node 304, the format translation layer 308 can convert the common messaging format MSG_{SF} of the first message 310 to a second data format MSG_{F2} that is native to the data node 304. Thus, the messaging interface 216 can publish the first message 310 in the second data format MSG_{F2} to be received by the data node 304.

In response to the data request for the energy-related data corresponding to the first message 310, the data node 304 can provide the requested energy-related data as a second message 312. In the example of FIG. 3, the second message 312 is demonstrated in a second data format MSG_{F2} that is native to the respective data node 304. The second message 312 is published to the messaging interface 216. The format translation layer 306 of the messaging interface 216 is configured to convert the second data format MSG_{F2} to the common messaging format MSG_{SF}. Upon the second message 312 being provided in the common messaging format MSG_{SF}, the processing layer 308 can process the second message 312, such as to determine one or more recipients (e.g., the processing agent 302) and/or to provide any additional processing on the second message 312. In response to determining that the second message 312 is intended for the processing agent 302, the format translation layer 308 can convert the common messaging format MSG_{SF} of the second message 312 to the first data format MSG_{F1} that is native to the processing agent 302. Thus, the messaging interface 216 can publish the second message 312 in the first data format MSG_{F1} to be received by the processing agent 302. Accordingly, the format translation layer 306 can provide for the capability of the messaging interface 216 to facilitate communication between the processing agents 202 and the data nodes 214 having disparate messaging protocols and data formats.

Given that the messaging interface 216 is a messaging framework across multiple organizations, the messaging interface 216 can be configured as part of a local area network (LAN), a wide area network (WAN), or provided on the Internet. The messaging interface 216 can thus be distributed across multiple computing devices, such as residing on a cloud computing environment or distributed across multiple enterprise servers. As an example, the messaging interface 216 can be implemented in an open-ended architectural manner, such that programmers can interface with the messaging interface 216 in any of a variety of programming formats. Referring back to the example of FIG. 2, the energy management system 200 includes a data repository 218 that includes distributed memory 220. The data repository 218 can be implemented as data storage for the messages that are propagated on the messaging interface 216. The distributed memory 220 can thus correspond to memory storage on the cloud computing environment and/or enterprise servers on which the messaging interface 216 itself can be provided.

In the example of FIG. 2, the energy management system 200 also includes a timing controller 222 that is configured to generate the trigger signals TRG that are provided to each of the processing agents 202. The timing controller 222 includes a real-time clock (“RTC”) 224, such that the timing controller 222 can generate the trigger signals TRG at periodic intervals based on the real-time clock 224. The periodic intervals can vary between the processing agents 202, such as based on the parameters of the processing agents 202 (e.g., based on the configuration files 210). In addition, the timing controller 222 includes a trigger generator 226 that is configured to selectively provide the trigger signal TRG to specific processing agents 202, such as in a simulation environment. The trigger signal TRG can be operated based on an automated simulation protocol, or can be operated manually by operators/programmers that are monitoring the energy management system 200. Therefore, the trigger generator 226 can simulate timing intervals associated with the real-time clock at each trigger signal TRG. As an example, the trigger generator 226 can operate in conjunction with the real-time clock 224 to provide a simulated accelerated time to provide the trigger signal at simulated time intervals (e.g., one simulated hour every second). For example, if a given processing agent 202 is configured to publish a message (e.g., a request or output) every hour during normal operation, the trigger generator 226 can generate the trigger signal twenty-four times in response to manual or accelerated prompts over the course of a short duration (e.g., seconds) to simulate the operation of a processing agent 202 over the course of an entire day.

One or more of the data nodes 214 can provide or perform respective functions in response to the outputs provided from the processing agents 202 via the messaging interface 216. For example, the outputs can, in the aggregate, correspond to or be used to determine a solution for the utility power system 100. In the example of FIG. 2, the energy management system 200 includes an output resolver 228 that is configured to access the data repository 218 to generate an energy management output (“EMO”) 230 that can be associated with the solution for the utility power system 100. The output resolver 228 can, for example, monitor the messages transmitted on the messaging interface 216 (e.g., including the outputs associated with the energy-related data provided from the processing agents 202) via the data repository 218 to determine the energy management output 230. The output resolver 228 can thus publish the energy management output 230 to one or more of the data nodes 214 of respective power generation facilities, related organizations, and/or administrative facilities via the messaging interface 216. Thus, a solution associated with the utility power system 100 (e.g., associated with the power generator system(s) 102) can be determined.

The solution can be any of a variety of solutions that can direct a course of action to improve efficiency, revenue, or overall operation of the utility power system 100. One example can correspond to generating a pricing menu for providing power to energy consumers on an energy marketplace. In this example, the processing agents 202 can include first processing agents 202 that are each associated with one of multiple power generator systems 102, such as including different types of power generator systems 102 (e.g., a fossil-fuel plant, a solar farm, a wind farm, etc.). Each of these first processing agents 202 can thus publish data requests for data associated with anticipated power-providing capability for the next day in response to the trigger signal TRG. The messaging interface 216 can receive the data requests and can access the requested data from the data nodes 214 corresponding to each of the respective power generator systems 102. The messaging interface 216 can thus publish the energy-related data from the data nodes 214 to the respective first processing agents 202. A second processing agent 202 can be associated with a battery power system (e.g., one of the power generator system(s) 102) that can store ancillary power from the power grid 104. Thus, the second processing agent 202 can request a state of charge of the battery power system via the messaging interface 216 in response to the trigger signal TRG, similar to as described above regarding the first processing agents 202 that monitor the other power generator systems 102.

One or more third processing agents 202 can each be associated with an outside organization, such as an organization that monitors meteorological conditions associated with the geographic region at which one or more of the power generator system(s) 102 is located. As an example, the third processing agent(s) 202 can publish data requests for data associated with anticipated weather conditions that may affect one or more of the power generator system(s) 102 for the next day, such as cloud-cover that may affect a solar farm and/or wind speeds that may affect a wind farm, in response to the trigger signal TRG. The messaging interface 216 can receive the data requests and can access the requested data from the data nodes 214 corresponding to each of the external organizations (e.g., the environmental and meteorological organizations 112). The messaging interface 216 can thus publish the energy-related data from the respective data nodes 214 to the respective third processing agent(s) 202.

A fourth processing agent 202 can operate as a data aggregator. As an example, each of the first, second, and third processing agents 202 can provide outputs corresponding to the energy-related data that each of the first, second, and third processing agents 202 had requested (e.g., subsequent to some processing of the energy-related data) to the messaging interface 216 in response to the trigger signal TRG. The fourth processing agent 202 can be configured to provide data requests for the outputs from the first, second, and third processing agents 202 to the messaging interface 216 in response to the trigger signal TRG. In response to receiving the data corresponding to the outputs from the first, second, and third processing agents 202 from the messaging interface 216, the fourth processing agent 202 can be configured to process the respective outputs to generate an aggregate of available energy from the power generator system(s) 102 (e.g., including the battery power system associated with the second processing agent 202) for the time associated with the data requests from the first, second, and third processing agents 202. The fourth processing agent 202 can thus provide the aggregate available energy as an output to the messaging interface 216.

A fifth processing agent 202 can be configured to generate an energy offering. As an example, the fifth processing agent 202 can provide data requests for the aggregate available energy provided in the output from the fourth processing agent 202 to the messaging interface in response to the trigger signal TRG. In response to receiving the aggregate available energy, the fifth processing agent 202 can provide one or more energy offerings as an output to the messaging interface 216. The messaging interface 216 can then provide the energy offering(s) to a data node 214 corresponding to an external organization, such as an energy marketplace for the associated geographic region (e.g., corresponding to one of the energy supplier organizations 114). The consumers 108 of the geographic region can thus be provided one or more energy options based on the available energy. As an example, and as described in greater detail below, the output resolver 228 can generate the energy management output 230 corresponding to the energy offering(s). As an example, the energy management output 230 can be determinative of a solution for optimizing revenue for providing power based on the energy offering(s) to the associated marketplace and/or power-providing organization.

The above example is provided simplistically, in that there could be significantly more processing agents 202 and/or data nodes 214 involved in providing the energy offer(s) to the energy marketplace. Additionally, the transfer of data can be provided in different ways. For example, the first processing agents 202 could be configured to determine the available power output based on the output from the third processing agent(s) 202, instead of the output from the third processing agent(s) 202 being provided to the fourth processing agent 202. Therefore, the above example is provided as but one simplified example, and that other examples, such as monitoring performance of available power from the power generator system(s) 102, monitoring and minimizing carbon output from power generator system(s) 102 and associated facilities, or any of a variety of energy related solutions can be implemented by the energy management system 200.

In the example of FIG. 2, the energy management system 200 further includes a simulation controller 232. The simulation controller 232 can be configured to selectively replace the energy-related data provided to or from the data nodes 214 with simulation data SIM in order to simulate operation of aspects of the utility power system 100. Therefore, the energy management output 230 can be based on real-world data provided from the data nodes 214, the simulation data SIM, or a combination of the real-world data and the simulation data SIM. As an example, the simulation data SIM that propagates between the processing agents 202 and the data nodes 214 on the messaging interface 216 can be tagged (e.g., in metadata) as simulated, such as to prevent real-world actions and/or consequences in response to the simulated data SIM. In the example of FIG. 2, the simulation controller 232 can exhibit control over the timing controller 222, such as to generate the trigger signal TRG via the trigger generator 226. For example, the trigger generator 226 can be manually controlled by an operator via the simulation controller 232 to provide the trigger signal TRG at arbitrary intervals, or the simulation controller 232 can be programmed to provide the trigger signal TRG via the trigger generator 226 at predefined intervals. Therefore, the operation of the energy management system 200 in a simulation environment can be controlled with respect to the timing of the messages provided between the processing agents 202 and the data nodes 214 via the messaging interface 216 based on the trigger signal TRG generated by the trigger generator 226, as provided by the simulation controller 232.

The simulation data SIM is demonstrated in the example of FIG. 2 as being generated by the output resolver 228 based on the energy management output 230. For example, the energy management output 230 can correspond to or be associated with a solution for the power generator system(s) 102. Therefore, the simulation data SIM can be implemented to optimize, improve, troubleshoot, or otherwise dictate a course of action for the solution for the power generator system(s) 102 (e.g., such as to modify the facilities of the power generator system(s) 102). For example, the simulation data SIM can be implemented to replace a given set of data associated with one of the data nodes 214 to determine an effect on the energy management output 230. The effect of the simulation data SIM on the energy management output 230 can be determinative of a course of action for the solution associated with the power generator system(s) 102, such as to provide an action plan for modifying the operation, structure, or any other aspects of the power generator system(s) 102 to improve the desired solution.

As an example, a set of simulation data SIM can be generated by the output resolver 228 based on the energy management output 230 that is generated based on a prior set of simulation data SIM. For example, the output resolver 228 can be configured to generate the simulation data SIM in an iterative feedback manner, such as to implement a convergence algorithm to produce an optimal result for the solution based on the iteratively generated energy management output 230. For example, the output resolver 228 can be configured to identify a deviation in the energy management output 230 resulting from application of a prior set of the simulation data SIM relative to application of the energy-related data provided from one or more of the data nodes 214. In response to identifying the deviation, the output resolver 228 can generate a new set of the simulation data SIM based on the deviation to determine the solution for the power generator system(s) 102. The output resolver 228 can iteratively repeat the process of identifying the deviations and generating additional simulation data SIM, such as to converge on an optimal result and/or to generate a set of solutions for selection of a solution by administrators, programmers, and/or users monitoring the output resolver 228.

In the example of convergence, the output resolver 228 can iteratively provide the simulation data SIM to generate an energy management output 230 that is based on weighted considerations or factors that can be programmed into the output resolver 228. For example, the energy management output 230 can have multiple constraints of varying importance, such as based on competing, complementary, and/or ancillary considerations with respect to each other. The output resolver 228 can be programmed to apply different weight factors to each of the multiple constraints based on a relative importance of the weight factors. Therefore, the different constraints that can dictate the solution in the energy management output 230 can be separately weighted, such that the output resolver 228 can converge on an optimal solution that maximizes benefits and minimizes detriments based on the weight factors of the different constraints. As another example, the weight factors themselves can be iteratively changed as part of the simulation data SIM, such that the output resolver 228 can generate multiple solutions based on a variable importance of the constraints relative to each other.

While the example of FIG. 2 demonstrates that the simulation data SIM is provided from the simulation controller 232 to the data nodes 214, this is demonstrated for simplicity, in that the simulation data SIM can instead be provided to the messaging interface 216 to facilitate replacement of the data associated with the data nodes 214 in the messaging interface 216 (e.g., in the processing layer 308), and not the actual data nodes 214. As another example, simulated messages corresponding to a set of simulation data SIM can be generated in the data nodes 214, such as in response to identifying requests for simulation data SIM (e.g., from the processing agents 202 operating in a simulation mode).

As an example, in response to an initially generated energy management output 230, the output resolver 228 can be configured to or commanded to generate an initial set of simulation data SIM that is provided to the simulation controller 232. The simulation controller 232 can thus replace the corresponding data to or from the respective data nodes 214 with the simulation data SIM. The energy management system 200 can thus provide an updated energy management output 230 at the output resolver 228 based on the simulation data SIM. The output resolver 228 can thus modify the simulation data SIM based on the updated energy management output 230 to run a second iteration of the simulation with the modified simulation data SIM. The modification of the simulation data SIM can be based on a step-wise function or a statistical algorithm to provide modifications having an amplitude that is based on the effect of the modified simulation data SIM in the previous iteration on the presently generated energy management output 230. Accordingly, the energy management system 110 can be continuously operated to generate the energy management data 230 in each of multiple iterations of modified simulation data SIM to converge on an energy management output 230 that corresponds to an optimal solution for the utility power system 100.

In a simulation environment, such as described above, the processing agents 202 can operate in a manner that is completely agnostic to the simulated data with which the processing agents 202 interact. Therefore, the processing agents 202 can function based on the run function 208 without any acknowledgement or modification based on the interaction with the simulation data SIM. As another example, in addition to the simulation data SIM being provided to replace the data associated with the data nodes 214, the simulation data SIM can correspond to the data requested by or output from the processing agents 202. For example, the processing agents 202 can be agnostic as to whether the energy-related data and/or the trigger signal TRG provided during real-time operation or provided in a simulation environment. Instead, the processing agents 202 can be configured to provide the programmed run function regardless of real-time or simulated operation of the energy management system. Therefore, the processing agents 202 need not be programmed to identify a distinction between simulation or normal operating conditions, as described herein. As another example, the energy management system 200 can include redundant processing agents 202 that are identical with respect to run function 208 and configured to operate in parallel with real-world energy-related data and simulation data, respectively. As another example, redundant processing agents 202 can operate based on one or more processing agents 202 operating with different sets of simulation data SIM and/or operating alongside a respective processing agent 202 that operates with real-world energy-related data.

FIG. 4 illustrates an example block diagram 400 of simulation capability of an energy management system. The diagram 400 includes the interaction of the simulation controller 232 with the messaging interface 216 and the processing agents 202. Therefore, reference is to be made to the example of FIG. 2 in the following description of the example of FIG. 4.

The diagram 400 includes the messaging interface 216, the simulation controller 232, and the processing agents 202. In the example of FIG. 4, the simulation controller 232 is demonstrated as providing a toggle signal to a simulation toggle 402 of the messaging interface 216, with the toggle signal being demonstrated as a signal TGL. The toggle signal TGL can indicate that at least a portion of the operating environment of the energy management system 200 is to be simulated. As an example, the simulation toggle 402 can provide selective disablement of one or more of the data nodes 214 in response to and/or defined by the toggle signal TGL. Therefore, the simulation toggle 402 can define which data nodes 214 are to be simulated, such that the energy-related data of the respective disabled data nodes 214 can instead be simulated. Additionally, the toggle signal TGL can dictate timing control of one or more of the processing agents 202, such as to control of the trigger signal TRG that is provided from the timing controller 222 to the respective selected one or more of the processing agents 202 to control the timing of simulation.

In the example of FIG. 4, the messaging interface 216 is demonstrated as receiving the energy-related data ERD from the data nodes 214. As an example, the energy-related data ERD can be provided in response to data requests, such as provided from the processing agents 202. The messaging interface 216 is also demonstrated as receiving simulation data SIM from the simulation controller 232. The simulation data SIM can be provided to replace at least some of the energy-related data ERD, such as based on the selective disablement of the respective data nodes 214 from which the replaced energy-related data ERD is provided. For example, in the simulation mode, the simulation controller 232 can be configured to append the messages of the simulation data SIM provided to the messaging interface 216 with a flag or tag (e.g., in metadata) to indicate simulation to the messaging interface 216. In the example of FIG. 4, data corresponding to the energy-related data ERD and/or the simulation data SIM is provided to the processing agents 202.

As an example, the processing agents 202 can be agnostic as to whether the received data is energy-related data ERD or simulation data SIM. Therefore, the signals provided from the messaging interface 216 to the processing agents 202 are demonstrated in the example of FIG. 4 as ERD/SIM₁ through ERD/SIM_{N}. Accordingly, regardless of the whether the received data is energy-related data ERD or simulation data SIM, the processing agents 202 can implement respective run functions 208 (e.g., in response to the trigger signal TRG, provided in real-time or through simulation).

Therefore, as described above, the simulation data SIM can be provided to one or more of the processing agents 202 instead of energy-related data ERD to optimize, improve, troubleshoot, or otherwise dictate a course of action for the solution for the power generator system(s) 102 (e.g., such as to modify the facilities of the power generator system(s) 102). For example, the simulation data SIM can be implemented to replace a given set of data associated with one of the data nodes 214 to determine an effect on the energy management output 230. The effect of the simulation data SIM on the energy management output 230 can be determinative of a course of action for the solution associated with the power generator system(s) 102, such as to provide an action plan for modifying the operation, structure, or any other aspects of the power generator system(s) 102 to improve the desired solution. As also described above, the output resolver 228 can be configured to generate the simulation data SIM in an iterative feedback manner, such as to implement a convergence algorithm to produce an optimal result for the solution based on the iteratively generated energy management output 230.

Referring back to the example of FIG. 2 and the above described example of implementing the energy management system 200 for providing an energy offer on the energy marketplace, the simulation controller 232 can be implemented, for example, to optimize the output for the energy offering provided to the energy marketplace. For example, in response to the energy management output 230 corresponding to the initial energy offering, the output resolver 228 can be configured to generate the simulation data SIM to optimize a solution associated with increasing available power for offer on the energy marketplace (e.g., to increase revenue for the energy offerings on the energy marketplace) and/or to optimize revenue for the power that is available and offered on the energy marketplace.

As an example, the output resolver 228 can be configured to initially generate the simulation data SIM to replace the data provided from one of the data nodes 214 corresponding to the available battery power for the next day. The output resolver 228 could thus determine based on the energy management output 230 that increasing the battery state of charge for the battery power system could result in greater available power for the energy offering. However, such a consideration could conflict with other power generator system(s) 102 that can be implemented to increase the state of charge of the battery power system in enough time to have a greater power availability in the energy offer in the time allotted for the consumer request(s). Therefore, in this example, the output resolver 228 could iteratively modify the simulation data SIM to increase power production of other power generator system(s) 102 to charge the battery power system to determine the effects on the energy management output 230 with respect to available power that can be provided in the energy offer constrained against increases in cost, resources, and/or capability (e.g., with respect to weather or other operating conditions) of operating the other power generator system(s) 102. Therefore, by iteratively providing the simulation data SIM to provide iterations of the energy management output 230, the output resolver 228 can determine an optimal solution for maximizing available energy for the energy offering on the energy marketplace in a most cost-effective manner based on changes to and/or considerations of other power generator system(s) 102. As an example, the energy management output 230 can also include operational instructions for the power generator system(s) 102 in order to achieve the optimal solution defined in the energy management output 230. Such instructions can thus be disseminated to the appropriate data nodes 214 from the output resolver 228 via the messaging interface 216 to facilitate a course of action to achieve the optimal solution.

The above is but one example of the generation and use of the simulation data SIM to drive an optimized solution for the utility power system 100. Other examples can include determining if and when to repair equipment associated with the power generator system(s) 102, changes to the operation of the power generator system(s) 102, troubleshooting errors associated with reports from the power generator system(s) 102, etc. Accordingly, the energy management system 200 can be implemented to control and simulate any and all aspects of power generation and consumption associated with the utility power system 100.

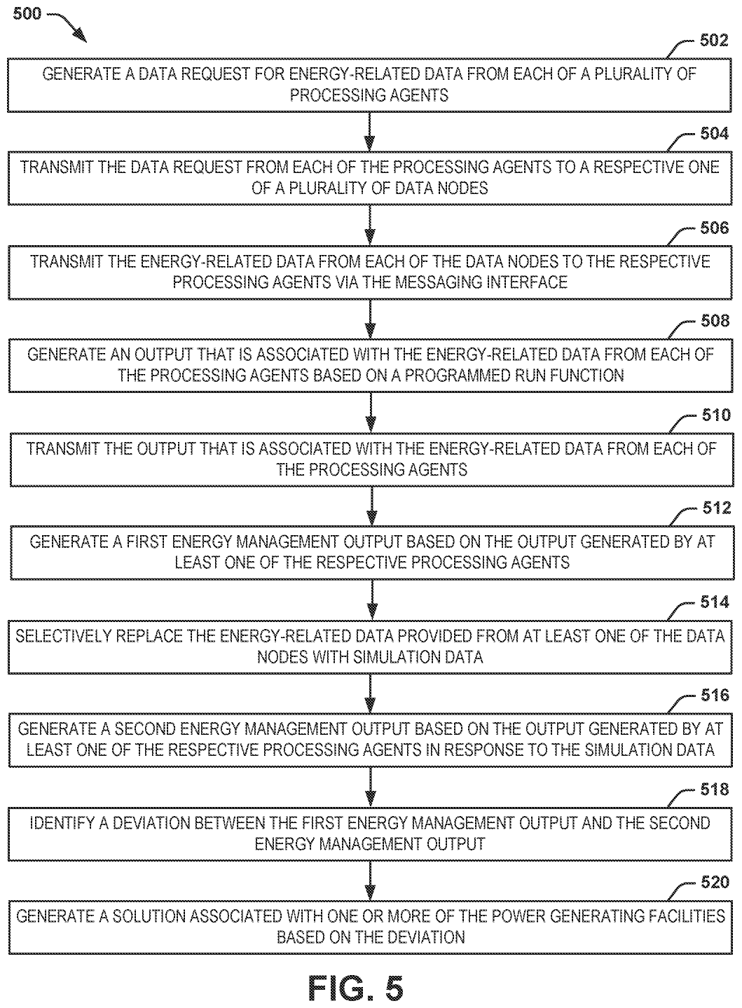

In view of the foregoing structural and functional features described above, a methodology in accordance with various aspects of the present invention will be better appreciated with reference to FIG. 5. While, for purposes of simplicity of explanation, the methodology of FIG. 5 is shown and described as executing serially, it is to be understood and appreciated that the present invention is not limited by the illustrated order, as some aspects could, in accordance with the present invention, occur in different orders and/or concurrently with other aspects from that shown and described herein. Moreover, not all illustrated features may be required to implement a methodology in accordance with an aspect of the present invention.

FIG. 5 illustrates method 500 for operating an energy management system (e.g., the energy management system 110). At 502, a data request (e.g., the message MSG₁) for energy-related data (e.g., the message MSG₂) is generated from each of a plurality of processing agents (e.g., the processing agents 202). At 504, the data request is transmitted from each of the processing agents to a respective one of a plurality of data nodes (e.g., the data nodes 214) that are each associated with associated with one of a respective organization (e.g., the energy supplier organizations 114 and/or the environmental and meteorological organizations 112), a respective one of a plurality of power generating systems (e.g., the power generating system(s) 102), or another one of the processing agents via a messaging interface (e.g., the messaging interface 216). At 506, the energy-related data is transmitted from each of the data nodes to the respective processing agents via the messaging interface. At 508, an output that is associated with the energy-related data is generated from each of the processing agents based on a programmed run function (e.g., the run function 208) associated with each of the respective processing agents.

At 510, the output that is associated with the energy-related data is transmitted from each of the processing agents to at least one of other processing agents and respective data nodes. At 512, a first energy management output (e.g., the energy management output 230) is generated based on the output generated by at least one of the respective processing agents in response to the energy-related data via an output resolver (e.g., the output resolver 228). At 514, the energy-related data provided from at least one of the data nodes is selectively replaced with simulation data (e.g., the simulation data SIM). At 516, a second energy management output (e.g., the energy management output 230) is generated based on the output generated by at least one of the respective processing agents in response to the simulation data via the output resolver. At 518, a deviation between the first energy management output and the second energy management output is identified. At 520, a solution associated with one or more of the power generating facilities is generated based on the deviation.

What have been described above are examples of the disclosure. It is, of course, not possible to describe every conceivable combination of components or method for purposes of describing the disclosure, but one of ordinary skill in the art will recognize that many further combinations and permutations of the disclosure are possible. Accordingly, the disclosure is intended to embrace all such alterations, modifications, and variations that fall within the scope of this application, including the appended claims. Additionally, where the disclosure or claims recite “a,” “an,” “a first,” or “another” element, or the equivalent thereof, it should be interpreted to include one or more than one such element, neither requiring nor excluding two or more such elements. As used herein, the term “includes” means includes but not limited to, and the term “including” means including but not limited to. The term “based on” means based at least in part on.

What is claimed is:

1. A system comprising:
a non-transitory memory that stores machine-readable instructions; and
a processing unit that accesses the memory and executes the machine-readable instructions, the machine-readable instructions comprising an energy management system, the energy management system comprising:
a plurality of processing agents, each of the processing agents comprising a run function configured to provide a data request for energy-related data and to generate an output that is associated with the energy-related data;
a messaging interface that is configured to receive the energy-related data from one or more data nodes that are each associated with one of a respective organization, a respective one of a plurality of power generating systems, or another one of the processing agents in response to the data request, to publish the energy-related data to the respective processing agent, to receive the output associated with the energy-related data from a respective one of the processing agents, and to provide the output to at least one of other processing agents and respective data nodes;
a simulation controller configured to selectively replace the energy-related data with simulation data for at least one of the one or more data nodes; and
an output resolver configured to generate an energy management output based on the output provided by at least one of the respective processing agents, the output resolver being further configured to generate the simulation data based on a deviation in the energy management output resulting from application of the simulation data relative to application of the energy-related data to determine a solution associated with one or more of the power generating facilities.

2. The system of claim 1, wherein the output resolver is configured to iteratively generate the energy management output and to refine the simulation data at each iteration based on the energy management output that is generated in response to a set of the simulation data in an immediately preceding iteration.

3. The system of claim 2, wherein the energy management output comprises a plurality of constraints, wherein the output resolver is configured to apply a weight factor to each of the constraints in generating the energy management output, such that the output resolver is configured to refine the simulation data at each iteration to optimize the solution associated with one or more of the power generating facilities based on respective weight factors of each of the constraints.

4. The system of claim 1, further comprising an agent generation tool configured to at least one of generate new processing agents and modify configuration files of existing processing agents.

5. The system of claim 1, wherein the messaging interface comprises a simulation toggle to activate a simulation mode in which at least one of the data nodes is selectively disabled to replace the energy-related data associated with the respective at least one of the data nodes with simulated data to facilitate simulation of operation of the respective run function with respect to the data request and the output.

6. The system of claim 1, further comprising a timing controller configured to provide a trigger signal to each of the processing agents to implement the respective run function, the timing controller comprising a real-time clock to periodically generate the trigger signal in real time.

7. The system of claim 6, wherein the timing controller further comprises a simulation trigger configured to generate the trigger signal in response to a command from the simulation controller to simulate operation of the real-time clock.

8. The system of claim 1, wherein the run function of at least one of the processing agents comprises providing a request for mandatory energy-related data and a request for optional energy-related data, and further comprises generating a mandatory output associated with the mandatory energy-related data and generating an optional output associated with the optional energy-related data.

9. The system of claim 1, wherein the messaging interface comprises:
a format translation layer configured to translate data formats of input messages associated with each of the processing agents and each of the data nodes to a common messaging format, and to translate output messages from the common messaging format to respective native data formats of each of recipient processing agents and recipient data nodes; and
a processing layer configured to process the input messages in the common messaging format to determine at least one recipient processing agent or data node for each input message.

10. The system of claim 1, wherein the simulation data comprises a metadata tag that is indicative of the simulation data being intended for simulation to mitigate real-world response of the respective organization or the respective one of a plurality of power generating systems in response to the simulation data.

11. A method for operating an energy management system, the method comprising:
generating a data request for energy-related data from each of a plurality of processing agents;
transmitting the data request from each of the processing agents to a respective one of a plurality of data nodes that are each associated with one of a respective organization, a respective one of a plurality of power generating systems, or another one of the processing agents via a messaging interface;
transmitting the energy-related data from each of the data nodes to the respective processing agents via the messaging interface;
generating an output that is associated with the energy-related data from each of the processing agents based on a programmed run function associated with each of the respective processing agents;
transmitting the output that is associated with the energy-related data from each of the processing agents to at least one of other processing agents and respective data nodes;
generating a first energy management output based on the output generated by at least one of the respective processing agents in response to the energy-related data via an output resolver;
selectively replacing the energy-related data provided from at least one of the data nodes with simulation data;
generating a second energy management output based on the output generated by at least one of the respective processing agents in response to the simulation data via the output resolver;
identifying a deviation between the first energy management output and the second energy management output; and
generating a solution associated with one or more of the power generating facilities based on the deviation.

12. The method of claim 11, wherein selectively replacing the energy-related data comprises selectively replacing the energy-related data provided from at least one of the data nodes with a first set of simulation data, wherein generating the second energy management output comprises generating the second energy management output based on the output generated by the at least one of the respective processing agents in response to the first set of simulation data via the output resolver, the method further comprising:
generating a second set of simulation data based on the deviation between the first energy management output and the second energy management output;
generating a third energy management output based on the output generated by the at least one of the respective processing agents in response to the second set of simulation data via the output resolver;
identifying a deviation between the second energy management output and the third energy management output; and
generating the solution associated with one or more of the power generating facilities based on the deviation between the second energy management output and the third energy management output.

13. The method of claim 12, further comprising:
iteratively generating energy management outputs based on the output generated by the at least one of the respective processing agents in response to a previous set of simulation data via the output resolver;
refining the simulation data at each iteration based on a respective energy management output that is generated in response to the previous set of the simulation data in an immediately preceding iteration; and
converging on the solution associated with one or more of the power generating facilities based on a plurality of iterations.

14. The method of claim 11, wherein transmitting the data request and transmitting the output that is associated with the energy-related data comprises transmitting the data request and transmitting the energy-related data from each of the processing agents in response to a trigger signal provided to the processing agents from a timing controller via the messaging interface, the method further comprising providing a simulation trigger signal from the timing controller to simulate a time duration provided from a real-time clock.

15. The method of claim 11, wherein transmitting the data request comprises:
translating a first native data format associated with each of the processing agents to a common messaging format via a format translation layer associated with the messaging interface;
processing the data request in the common messaging format to determine at least one recipient processing agent or data node for the data request via a processing layer associated with the messaging interface;
translating the data request from the common messaging format to a second native data format associated with the at least one recipient processing agent or data node via the format translation layer associated with the messaging interface; and
transmitting the data request to the at least one recipient processing agent or data node in the second native data format.

16. A non-transitory computer readable medium comprising machine-readable instructions, the machine-readable instructions being executed to:
generate a plurality of processing agents, each of the processing agents comprising a run function configured to provide at least one data request for energy-related data and to generate at least one output that is associated with the energy-related data;
generate a messaging interface that is configured to receive the energy-related data from one or more data nodes that are each associated with one of a respective organization, a respective one of a plurality of power generating facilities, or another one of the processing agents in response to the at least one data request, to publish the energy-related data to the respective processing agents, to receive the at least one output associated with the energy-related data from the respective processing agents, and to provide the at least one output to at least one of other processing agents and respective data nodes;
generate a simulation controller that is configured to selectively replace the energy-related data with simulation data for one or more of the data nodes; and
generate an output resolver that is configured to generate an energy management output based on at least one of the at least one output provided by a respective at least one of the respective processing agents, the output resolver being further configured to generate the simulation data based on deviations in the energy management output resulting from application of the simulation data relative to application of the energy-related data and to iteratively generate the energy management output and to refine the simulation data at each iteration based on the energy management output that is generated in response to a set of the simulation data in an immediately preceding iteration to determine a solution associated with one or more of the power generating facilities.

17. The medium of claim 16, wherein the energy management output comprises a plurality of constraints, wherein the output resolver is configured to apply a weight factor to each of the constraints in generating the energy management output, such that the output resolver is configured to refine the simulation data at each iteration to optimize the solution associated with one or more of the power generating facilities based on respective weight factors of each of the constraints.

18. The medium of claim 16, further comprising a timing controller configured to provide a trigger signal to each of the processing agents to implement the respective run function, the timing controller comprising a real-time clock to periodically generate the trigger signal in real time.

19. The medium of claim 18, wherein the timing controller further comprises a simulation trigger configured to generate the trigger signal in response to a command from the simulation controller to simulate operation of the real-time clock.

20. The medium of claim 16, wherein the messaging interface comprises:
a format translation layer configured to translate data formats of input messages associated with each of the processing agents and each of the data nodes to a common messaging format, and to translate output messages from the common messaging format to respective native data formats of each of recipient processing agents and recipient data nodes; and
a processing layer configured to process the input messages in the common messaging format to determine at least one recipient processing agent or data node for each input message.
